(19) United States
(12) Patent Application Publication
(10) Pub. No.: US 2017/0270679 A1
(43) Pub. Date: Sep. 21, 2017

(54) DETERMINING A HAIR COLOR TREATMENT OPTION

(71) Applicant: The Dial Corporation, Scottsdale, AZ (US)

(72) Inventor: Stephen Koven, Scottsdale, AZ (US)

(21) Appl. No.: 15/076,123

(22) Filed: Mar. 21, 2016

(51) Int. Cl. G06T 7/40; H04N 17/00; A45D 44/00; G06T 7/00

(52) U.S. Cl. CPC G06T 7/408; G06T 7/0018; H04N 17/002; A45D 44/005; G06T 2207/10024; G06T 2207/30196; A45D 2044/007

(57) ABSTRACT

Methods and systems are provided for determining a hair color treatment option. The methods and systems include calibrating a camera of the mobile device via a calibration card by determining calibration values from a calibration image captured by the camera, obtaining, with the camera, a first image of a user's hair, obtaining, with the camera, a second image of a target color, the target color representing a color to which the user desires to change at least a portion of the hair, and presenting, via a user interface (UI) of the mobile device, a recommendation, the recommendation providing at least one hair color treatment option to change at least the portion of the user's hair to the target color.

### FIELD OF THE INVENTION

The present invention generally relates to determining a hair color treatment option, and more particularly relates to determining a hair color treatment option based on a user's current color of hair and a target color.

### BACKGROUND OF THE INVENTION

A hair color treatment is the process of changing at least a portion of a person's hair from one color to another color. The main purpose of the hair color treatment is cosmetic. This includes changing the person's hair color to be fashionable, desirable, to cover grey hair, or to restore the person's hair to their natural color. Hair color treatment can be done at home by the person or professionally by a hairdresser.

Accordingly, it is desirable to determine a hair color treatment option that matches exactly what the person desires. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for determining a hair color treatment option. The method includes calibrating a camera of the mobile device via a calibration card by determining calibration values from a calibration image captured by the camera, obtaining, with the camera, a first image of a user's hair, obtaining, with the camera, a second image of a target color, the target color representing a color to which the user desires to change at least a portion of the hair, and presenting, via a user interface (UI) of the mobile device, a recommendation, the recommendation providing at least one hair color treatment option to change at least the portion of the user's hair to the target color.

A system for determining a hair color treatment option includes a calibration card for calibrating a camera of a mobile device, the calibration card includes a red region, a green region, and a blue region, the mobile device programmed to, with the camera, obtain a calibration image to calibrate the camera of the mobile device via the calibration card by determining calibration values from the calibration image, obtain a first image of a user's hair, and obtain a second image of a target color, the target color representing a color to which the user desires to change at least a portion of the hair, with a processor adjust the first image and the second image based on the calibration values determined from the calibration image to compensate for environmental factors that affect the first image and the second image, and with a UI present a recommendation, the recommendation providing at least one hair color treatment option to change at least the portion of the hair to the target color.

A computer program product is provided for determining a hair color treatment option. The computer program product includes a non-transitory tangible computer readable storage medium. The tangible computer readable storage medium includes computer readable program code embodied therewith, the computer readable program code includes program instructions that, when executed, cause a processor to obtain a first image of a user's hair, obtain a second image of a target color, the target color representing a color to which the user desires to change at least a portion of the hair, adjust the first image and the second image based on calibration values determined from a calibration image to compensate for environmental factors that affect the first image and the second image and present, via a UI, a recommendation, the recommendation providing at least one hair color treatment option to change at least the portion of the hair to the target color.

### BRIEF DESCRIPTION OF THE DRAWINGS

The present invention will hereinafter be described in conjunction with the following drawing figures, wherein like numerals denote like elements, and uses of the invention. Furthermore, there is no intention to be bound by any theory presented in the preceding background of the invention or the following detailed description of the invention.

FIG. 1 is a diagram of a system for determining a hair color treatment option, according to one example of principles described herein.

FIG. 2 is a diagram of a system for determining a hair color treatment option, according to one example of principles described herein.

FIG. 3A is an example of a first image, according to one example of principles described herein.

FIG. 3B is an example of a second image, according to one example of principles described herein.

FIG. 4A is an example of a user interface (UI) for displaying a recommendation, according to one example of principles described herein.

FIG. 4B is an example of a UI for displaying a recommendation, according to one example of principles described herein.

FIG. 5 is a flowchart of a method for determining a hair color treatment option, according to one example of principles described herein.

FIG. 6 is a flowchart of a method for determining a hair color treatment option, according to one example of principles described herein.

FIG. 7 is a diagram of a system for determining a hair color treatment option, according to one example of the principles described herein.

FIG. 8 is a diagram of a determining system, according to one example of the principles described herein.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, a hair color treatment is the process of changing a person's hair from one color to another color. To change a person's hair from one color to another color, the person selects a hair coloring product. The hair coloring product includes dyes and pigments that allow the person to change their hair from their current color to another color. For example, if a person desires to change their the color of their hair from blonde to black, the user selects a hair coloring product that includes black dyes and pigments. Further, to change a person's hair from one color to another color, a number of techniques are used. These techniques include an off-scalp technique and an on-scalp technique. The off-scalp technique allows the person to change their hair color to several different colors to produce streaks or gradations in the hair. This includes highlighting, lowlighting, ombre, and splashlights. The off-scalp technique is created by a number of methods. These methods include foiling, capping, balayae, and dipping or tip dyeing. The on-scalp technique allows the person to apply a hair coloring product on the scalp for more solid level coverage. This includes root touch up, all over color, and block coloring. Both the off-scalp technique and the on-scalp technique can use any type of hair coloring product. In some examples, such as highlighting, the person's hair is bleached before adding a hair coloring product.

Often, the person visually determines a color they desire to change their hair to and selects a hair coloring product. However, many variables arise during the process associated with the hair color treatment that results in the person's hair not changing to the color the person had in mind. For example, the hair coloring product may not match exactly what the person had in mind because the person could not visually determine the color they desired. This can be troublesome if the person is applying the hair coloring product to cover up grey roots. The person may have to subject their hair to a hair color treatment several times using different hair coloring products to obtain the desired color. This can result in the person becoming frustrated with the hair color product and hair color treatments.

The principles described herein include a system and a method for determining a hair color treatment option. Such a system and method include calibrating a camera of the mobile device via a calibration card by determining calibration values from a calibration image captured by the camera, obtaining, with the camera, a first image of a user's hair, obtaining, with the camera, a second image of a target color, the target color representing a color to which the user desires to change at least a portion of the hair, and presenting, via a user interface (UI) of the mobile device, a recommendation, the recommendation providing at least one hair color treatment option to change at least the portion of the user's hair to the target color. Such a method and system allow a user to change their hair color to an exact color.

In the present specification and in the appended claims, the term “environmental factors” means elements that affect digital images. Environmental factors include a type of light, an intensity of the light, quality of a camera that captures the digital images, other environmental factors, or combinations thereof that affect the digital image.

In the present specification and in the appended claims, the term “calibration card” means a mechanism used to calibrate color values produced by a camera of a mobile device. The calibration card includes a physical device having a number of regions of different, known colors. Consequently, a calibration image of the calibration card can provide calibration factors for the camera with which the calibration image was taken by comparing the known color values to the values at which the colors of the card appear in the calibration image. In some examples, the regions include a red region, a green region and a blue region.

In the present specification and in the appended claims, the term “calibration image” means a digital image of a calibration card. The calibration image is used to calibrate a camera, for example, of a mobile device.

In the present specification and in the appended claims, the term “target color” means a desired color. Specifically, the target color represents a color a user desires to change at least a portion of their hair.

In the present specification and in the appended claims, the term “recommendation” means a process or a series of step that are utilized to treat the user's hair. The steps of the recommendation are such that the user's hair is changed to a target color. The recommendation is displayed, via a UI, to the user.

In the present specification and in the appended claims, the term “calibration values” means an offset that is used to produce true representations of colors in the images. Calibration values are numbers between zero and two-hundred fifty five, for a red, green and blue (RGB) color scheme, that represents average RGB values of a red region, a green region, and a blue region of a calibration card in a calibration image. The calibration values are based on an analysis of pixels of the calibration image associated with the red region, the green region, and the blue region of the calibration card.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

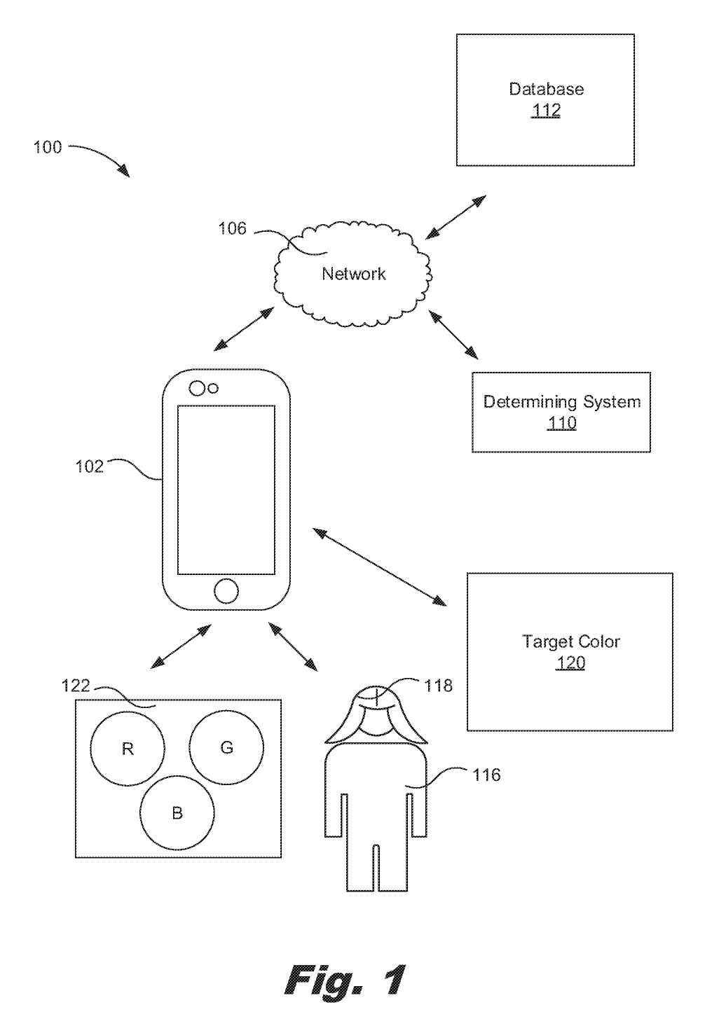

FIG. 1 is a diagram of a system for determining a hair color treatment option, according to one example of principles described herein. As will be described below, a determining system is in communication with a network to calibrate a camera of the mobile device via a calibration card by determining calibration values from a calibration image captured by the camera. Further, the determining system obtains, with the camera, a first image of a user's hair. The determining system obtains, with the camera, a second image of a target color, the target color representing a color to which the user desires to change at least a portion of the hair. Further, the determining system presents, via a UI of the mobile device, a recommendation, the recommendation providing at least one hair color treatment option to change at least the portion of the user's hair to the target color. More information about the determining system will be described below.

As illustrated in FIG. 1, the system (100) includes a mobile device (102). The mobile device (102) is a handheld device that allows a user (116) to capture digital images. As will be described in other parts of this specification, the camera of the mobile device (102) captures a calibration image, a first image, and a second image. In an example, the calibration image is a digital image of a calibration card (122). The first image is a digital image of the user's hair. The second image is a digital image of the target color (120).

The system (100) further includes a determining system (110). The determining system (110) calibrates a camera of the mobile device (102) via a calibration card (122) by determining calibration values from the calibration image captured by the camera. As will be described below, the calibration values are used to adjust color values of the first image and the second image, such that the determining system (110) compensates for the camera quality of the mobile device (102), skill of a user, and environmental factors. Environmental factors include a type of light, an intensity of the light, other environmental factors, or combinations thereof that affect the digital images.

The determining system (110) obtains, with the camera, a first image of a user's hair. The first image is used to determine the color of the user's hair. In some examples, the user's hair is several colors. As will be described below, the first image is adjusted based on the calibration values such that the color values in the first image are accurate.

Further, the determining system (110) obtains, with the camera, a second image of a target color (120), the target color (120) representing a color to which the user (116) desires to change at least a portion of the hair (118). The second image is a digital image captured from a website, a magazine, a UI, or a display. As will be described below, the second image is adjusted based on the calibration values such that the color values in the second image are accurate.

The determining system (110) further presents, via a UI of the mobile device (102), a recommendation, the recommendation providing at least one hair color treatment option to change at least the portion of the user's hair to the target color. The hair color treatment option includes a hair coloring product to use that exactly matches the target color. In other examples, the hair color treatment option specifies a technique used to change at least the portion of the user's hair to the target color. These techniques include an off-scalp technique and an on-scalp technique. For example, if more than one target color is identified by the determining system (110), the recommendation also includes an off-scalp technique to allow the user (116) to change portions of their hair to the target colors to produce streaks or gradations in the hair. In some examples, the recommendation includes steps or procedures for the techniques.

The calibration image, the first image, the second image, and recommendations are stored in a database (112). This allows companies to access the database (112) to track trends and create custom hair coloring products if needed. As a result, the user (116) changes their hair color to an exact color. More information about the determining system (110) will be described later on in this specification.

While this example has been described with reference to the determining system being located over the network, the determining system may be located in any appropriate location according to the principles described herein. For example, the determining system may be located in a mobile device, a server, a datacenter, other locations, or combinations thereof.

While this example has been described with reference to a mobile device, a permanent device may be used. The permanent device includes the same features and functions of the mobile device. However, the permanent device cannot be easily moved from one location to another location. This permanent device is desirable for professional salons.

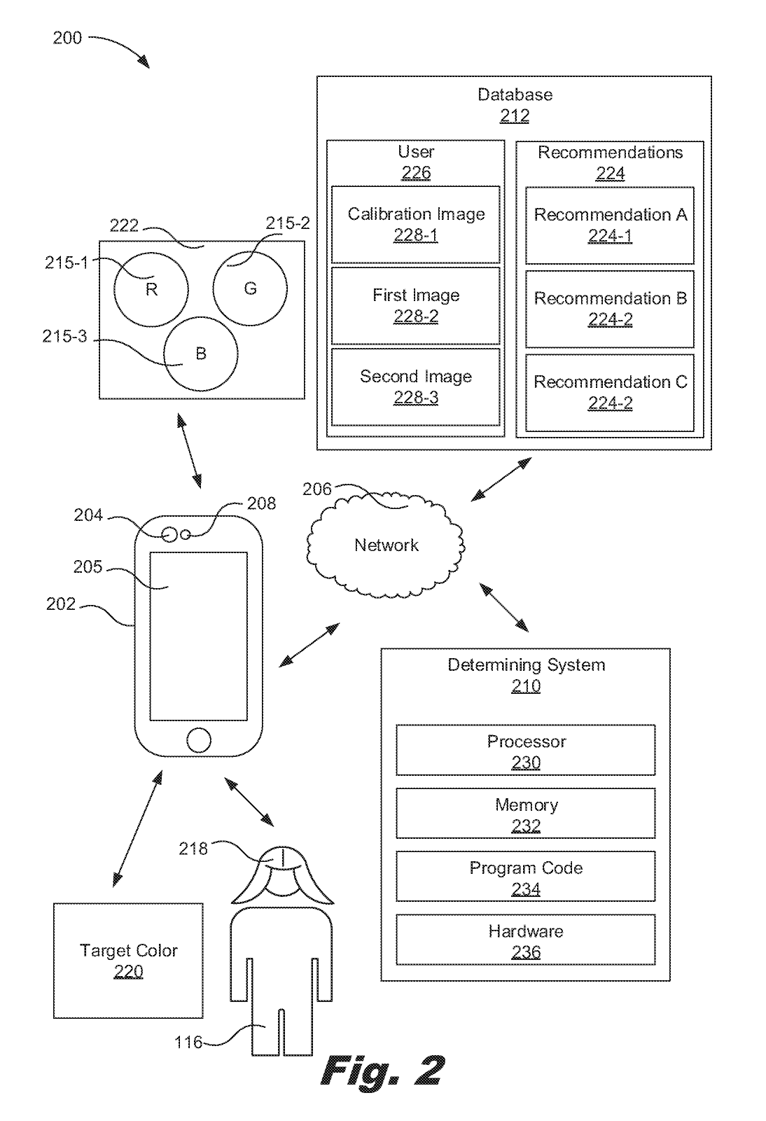

FIG. 2 is a diagram of a system for determining a hair color treatment option, according to one example of principles described herein. As will be described below, a determining system is in communication with a network to calibrate a camera of the mobile device via a calibration card by determining calibration values from a calibration image captured by the camera. Further, the determining system obtains, with the camera, a first image of a user's hair. The determining system obtains, with the camera, a second image of a target color, the target color representing a color to which the user desires to change at least a portion of the hair. Further, the determining system presents, via a UI of the mobile device, a recommendation, the recommendation providing at least one hair color treatment option to change at least the portion of the user's hair to the target color. More information about the determining system will be described below.

As illustrated in FIG. 2, the system (200) includes a mobile device (202). The mobile device (202) includes a number of features. The features include a camera (204) to capture a calibration image (228-1) of a calibration card (222), a first image (228-2) of the user's hair (218), and a second image (228-3) of a target color (220). The mobile device (202) includes other features that compensate for environmental factor such as elements that affect digital images. Environmental factors include a type of light, an intensity of the light, quality of a camera that captures the digital images, other environmental factors, or combinations thereof that affect the digital image. The other features include a light source (208) to illuminate the calibration card (222), the user's hair (218), and/or the target color (220) while capturing the digital images. In some environments the natural lighting is be poor. Natural lighting that is poor results in a poor quality of the digital images associated with the calibration card (222), the user's hair (218), and the target color (220). As a result, the light source (208) may be activated while capturing the digital images such that the light source (208) illuminates the calibration card (222), the user's hair (218), and the target color (220). This results in useable digital images that can be analyzed by a determining system (210).

The features further include a UI (205). As will be described in other parts of this specification, the UI (205) allows the determining system (210) to present a recommendation to a user. The recommendation is a process or a series of step that are utilized to treat the user's hair. The steps of the recommendation are such that the user's hair (218) is changed to the target color (220).

As illustrated in FIG. 2, the system (200) includes a calibration card (222). The calibration card (222) is a mechanism used to calibrate color values produced by a camera (204) of a mobile device (202). The calibration card (222) includes a physical device having a number of regions (215) of different, known colors. Consequently, a calibration image of the calibration card (222) can provide calibration values for the camera (204) with which the calibration image was taken by comparing the known color values to the calibration values at which the colors of the calibration card appear in the image. The calibration card (222) includes a red region (215-1), a green region (215-2) and a blue region (215-3). As will be described below, when the mobile device (202) captures a calibration image of the calibration card (222), pixels of the calibration image associated with the red region (215-1), the green region (215-2) and the blue region (215-3) are analyzed to determine the calibration values for each of these regions (215). As a result, the calibration card (222) aids the determining system (210) in calibrating the first image and the second image such that the color values in the digital images for the user's hair (218) and the target color (220) are accurate. In some examples, a user does not have access to the calibration card (222). As a result, a pre-stored image is used instead. The pre-stored image is a digital image in the database (212) that has captured the target color (220) via several mobile devices and in several environments. Further, the pre-stored image compensates for limiting factors of the mobile device (202) and environmental factors as described above. As a result, the pre-stored image gives similar results as the calibration card (222).

While this example has been described with reference to the calibration card including a red region, a green, and a blue region, the calibration card may include other regions. For example, the calibration card may include a yellow region, a purple region, a black, a white region, other regions, or combinations thereof.

As illustrated, the system (200) includes a database (212). The database (212) stores, in memory, digital images (228) associated with a user (226). The database (212) stores, in memory, digital images (228). As illustrated the database (212) includes a calibration image (228-1). The calibration image (228-1) is a digital image of a calibration card. The calibration image (228-1) is used to calibrate a camera (204), for example, of a mobile device (202).

The database (212) includes a first image (228-2). The first image (222-2) is a digital image of a user's hair (218). This includes the color of the user's hair (218). The database (212) includes a second image (228-3).

The second image (222-3) includes a digital image of the target color (220). The target color (220) is a desired color. Specifically, the target color (220) represents a color a user (216) desires to change at least a portion of their hair (218). In some examples, the second image (228-3) is a digital image of another person's hair. In other examples, the second image (228-3) is a digital image of a color found in nature or is a manmade color. While this example has been described with reference to the second image (228-3) including the target color (220), the second image (228-3) includes a uniform resource locator (URL) link to the target color (220). For example, the second image (228-3) is a digital image of a bar code or a quick response (QR) code. The bar code or QR code is linked to a specific target color (220). For example, a bar code or QR code, when scanned, by the camera (204) of the mobile device (202) displays, via the UI (205), a hair coloring product that matches the target color (220).

Further, information is associated with the digital images (222). For example, calibration values are be associated with the calibration image (222-1). In some examples, calibration values are an offset that is used to produce true representations of colors in the images. Calibration values, for a RGB color scheme, are numbers between zero and two-hundred fifty five that represents average RGB values of a red region, a green region, and a blue region of a calibration card in a calibration image. The calibration values are based on an analysis of pixels of the calibration image associated with the red region, the green region, and the blue region of the calibration card. While this example has been described with reference to an RGB color scheme, other color schemes may be used.

Further, the database stores, in memory, recommendations (224). The recommendations (224) are a process or a series of step that are utilized to treat the user's hair. The steps of the recommendation are such that the user's hair is changed to a target color. The recommendation is displayed, via a UI, to the user. In an example, the recommendations (224) include recommendation A (224-1), recommendation B (224-2) and recommendation C (224-3). Recommendation A (224-1) is a recommendation that states perform an on-scalp hair color treatment with hair coloring product X to dye a portion of your hair to the target color. Recommendation B (224-2) is a recommendation that states perform an on-scalp hair color treatment with hair coloring product Y first to obtain the first target color. Then perform an off-scalp hair color treatment with hair coloring product Z to obtain the second target color. Recommendation C (224-3) is a recommendation that states bleach your hair with product X then perform an on-scalp hair color treatment with hair coloring product Y to obtain the first target color.

While this example has been described with reference to the database storing digital images for one user, the database may store digital images for multiple users. As a result, the determining system may utilize digital images as a large sample size to refine the recommendations or determine trends.

As illustrated, the system (200) includes a determining system (210). The determining system (210) includes, but not limited to, a processor (230), memory (232), program code (208), and/or hardware (236). The processor (230), memory (232), program code (208), and/or hardware (236) are used to implement the functionality of the system (200). For example, the memory (232) and/or program code (208) stores instructions that when executed cause the processor and/or hardware (236) to perform the functions described below.

The determining system (210) calibrates the camera (204) of the mobile device (202) via the calibration card (222) by determining the calibration values from the calibration image (228-1) captured by the camera (204). This includes the determining system (210) obtaining the calibration image (228-1) of the calibration card (222) from the mobile device (202). Once the calibration image (228-1) is obtained, the determining system (210) analyzes pixels of the calibration image (228-1) associated with a red region (215-1), a green region (215-2), and a blue region (215-3) of the calibration card (222). The determining system (210) determines, based on the pixels, the calibration values associated with the red region (215-1), the green region (215-2), and the blue region (215-3) of the calibration card. For example, if the known RGB value for the red region (215-1) is R:176, G:23, and B:31, but the RGB value in the calibration image (228-1) is R:170, G:23, and B:30, the calibration value for the red region (215-1) is R:7, G:0, and B:1 (i.e. the difference between the known RGB value and the RGB value in the calibration image). As a result, the calibration value for the red region (215-1) is used as on offset in the first image (228-2) and the second image (228-3). Similarly, calibration values for the green region (215-2) and the blue region (215-3) are determined and used as an offset as well in the first image (228-2) and the second image (228-3). As a result, a calibration value for the red region (215-1), a calibration value for the green region (215-2), and a calibration value for the blue region (215-3) are obtained. Again, these calibration values are used to compensate for environmental factors affecting the first image (228-2) and the second image (228-3) such that colors in the first image (228-2) and the second image (228-3) are accurately represented.

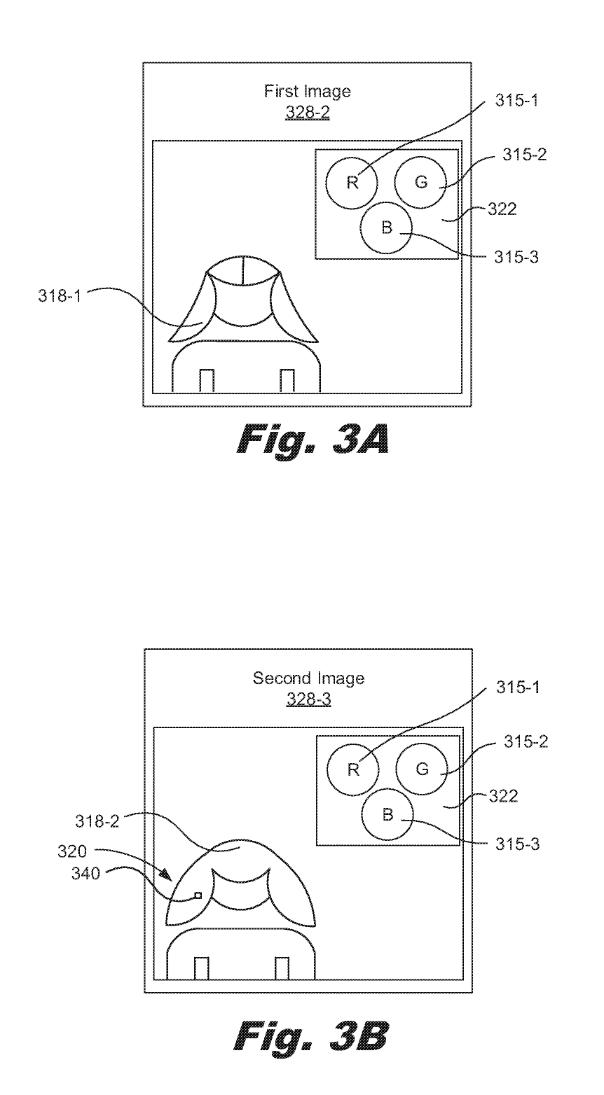

In some example, the camera (204) of the mobile device (202) is calibrated before obtaining the first image (228-2) and the second image (228-3) from the mobile device (202). In other examples, the calibration card (222) is included in the first image (228-2) and the second image (228-3) to calibrate the camera (204) of the mobile device (202). As a result, the calibration card (222) and the first image (228-2) and the calibration card (222) the second image (222-3) are photographed at the same time and are subjected to the same environmental factors. This example will be described in FIGS. 3A and 3B. In some examples, the environmental factors include shading errors. Shading errors are introduced by an intensity, angle, and color of an available lighting source. The lighting source might be dependent on environmental factors such as if the images are captured indoors or outdoors, if the available lighting source is natural light or artificial light, if the light source (208) is turned ON or OFF, other environmental factors, or combinations thereof. Further, since the user's hair (218), the target color (220) and the calibration card (222) are photographed at the same time, the digital images subjected to the same quality. The quality of can be based on characteristics of a lens of the camera (204), the number of pixels the digital sensor of the camera (204) can capture, if the digital image is blurred due to motion of the camera (204), or combinations thereof.

The determining system (210) obtains, with the camera (204), the first image (228-2). As mentioned above, the first image (228-2) is a digital image of a user's hair (218). The first image (228-2) includes, but is not limited to, at least one color associated with the user's hair (218). For example, the user's hair color might be blonde, red, black, brown, or another color. The pixels of the first image (228-2) are analyzed to determine the exact color of the user's hair (218). In some examples, the RGB color scheme is used to determine the exact color of the user's hair (218). This includes a number between zero and two-hundred fifty five that represent an average RGB value for the user's hair (218). Again the calibration values are used to determine the exact average RGB value for the user's hair (218). For example, if the calibration values indicate for a given digital image taken by the camera (204) of the mobile device (202), the average RGB value for the user's hair (218) should be adjusted, the first image (228-2) is adjusted as described above. This results in the color values of the first image (228-2) being accurate.

The determining system (210) obtains, with the camera (204), a second image (228-3). The second image (228-3) is a digital image of a target color (220). The target color (220) represents a color to which the user (216) desires to change at least a portion of the hair (218). The target color (220) is, for example, a specific yellow, blue, red, green, black, grey, or other target color.

The determining system (210) adjusts the first image (228-2) and the second image (228-3) based on the calibration values determined from the calibration image (228-1) to compensate for environmental factors that affect the first image (228-2) and the second image (228-3). As mentioned above, the calibration values are used as an offset to adjust the color values for the first image (228-2) and the second image (228-3).

To determine the target color (220) from the second image (228-3), a sample area is selected. The determining system (210) determines the sample area of the second image (228-3) related to the target color (220). This includes the user (216) selecting the sample area via a UI (205). The determining system (210) analyzes pixels of the sample area and determines, based on the pixels of the sample area, the target color (220). In an example, the sample area is at least a pixel. In some examples, the second image (228-3) is a digital image of another person's hair. Due to the shadows, waviness, and variations in the person's hair in the second image (228-3), often a single pixel is desired to be selected as the sample area. This ensures the exact color the user (216) desires is selected. In other examples, a sample area is more than a pixel. In this example, an average RGB value of the sample area is used to determine the target color (220). Again the calibration values are used to determine the exact RGB value for the target color (220) in the second image (228-3). For example, if the calibration values indicate for a given digital image taken by the camera (204) of the mobile device (202), the exact RGB value for the target color (220) should be adjusted by an RGB value of 5, the second image (222-3) is adjusted by an RGB value of 5. This results in the color values of the second image (222-3) being accurate.

While this example has been described with reference to needing a first image and a second image, a first image might only be needed if the target color is in the first image. For example, if the user desires to touch up the roots of their hair, only the roots of the hair need to be changed to the target color. In this example, the target color is the user's current color of hair excluding the color of the roots. As a result, only a first image is needed if the user desires to maintain their hair color.

The determining system (210) presents, via a UI (205) of the mobile device (202), a recommendation. In some examples, the recommendation provides at least one hair color treatment option to change at least the portion of the user's hair (218) to the target color (220). In an example, recommendation A (224-1) is presented via the UI (205) of the mobile device (202). In another example, recommendation B (224-2) is presented via the UI (205) of the mobile device (202).

Further, the determining system (210) stores the recommendations (224) in the database (212) for the user (216). In this example, recommendation A (224-1), recommendation B (224-2) and recommendation C (224-3) are stored in the database (212).

FIG. 3A is an example of a first image, according to one example of principles described herein. As mentioned above, the determining system obtains, with the camera, the first image. Although a calibration card is included in the first image of FIG. 3A, the first image may or may not include the calibration card depending on if the determining system has obtained a calibration image to determine calibration values or not.

As illustrated, the first image (328-2) is a digital image that includes the calibration card (322) photographed with the user's hair (318-1). Since the first image (328-2) includes the calibration card (322), the first image (328-2) is adjusted based on the calibration values determined by analyzing the pixels in the first image (328-2) associated with the red region (315-1), the green region (315-2), and the blue region (315-3).

FIG. 3B is an example of a second image, according to one example of principles described herein. As mentioned above, the determining system obtains, with the camera, the second image. Although a calibration card is included in the second image of FIG. 3B, the second image may or may not include the calibration card depending on if the determining system has obtained a calibration image to determine calibration values or not.

As illustrated, the second image (328-3) is a digital image that includes the calibration card (322) photographed with the target color (320). In this example, the second image (228-3) is a digital image of another person's hair (318-2). Since the second image (328-3) includes the calibration card (322), the second image (328-3) is adjusted based on the calibration values determined by analyzing the pixels in the second image (328-3) associated with the red region (315-1), the green region (315-2), and the blue region (315-3). As mentioned above, a sample area (340) is selected to determine a precise location on the second image (328-3) to analyze to determine the target color (320).

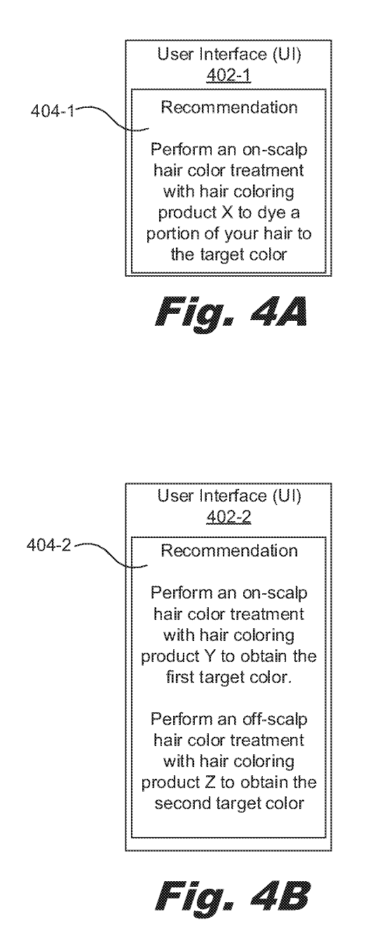

FIG. 4A is an example of a UI for displaying a recommendation, according to one example of principles described herein. As mentioned above, the determining system presents, via a UI of the mobile device, a recommendation.

As illustrated, a UI (402-1) presents, to a user, a recommendation (404-1) to change at least the portion of the user's hair to the target color. In this example, the recommendation (404-1) recommends perform an on-scalp hair color treatment with hair coloring product X to dye a portion of your hair to the target color.

FIG. 4B is an example of a UI for displaying a recommendation, according to one example of principles described herein. As mentioned above, the determining system presents, via a UI of the mobile device, a recommendation.

As illustrated, a UI (402-2) presents, to a user, a recommendation (404-2) to change at least the portion of the user's hair to the target color. In this example, the recommendation (404-2) recommends perform an on-scalp hair color treatment with hair coloring product Y to obtain the first target color. Perform an off-scalp hair color treatment with hair coloring product Z to obtain the second target color.

While the recommendations of FIGS. 4A and 4B include a technique for the hair color treatment option, the recommendations might only recommend the hair coloring product. As a result, the user can perform the technique for the hair color treatment via, for example, the instructions included on the hair coloring product.

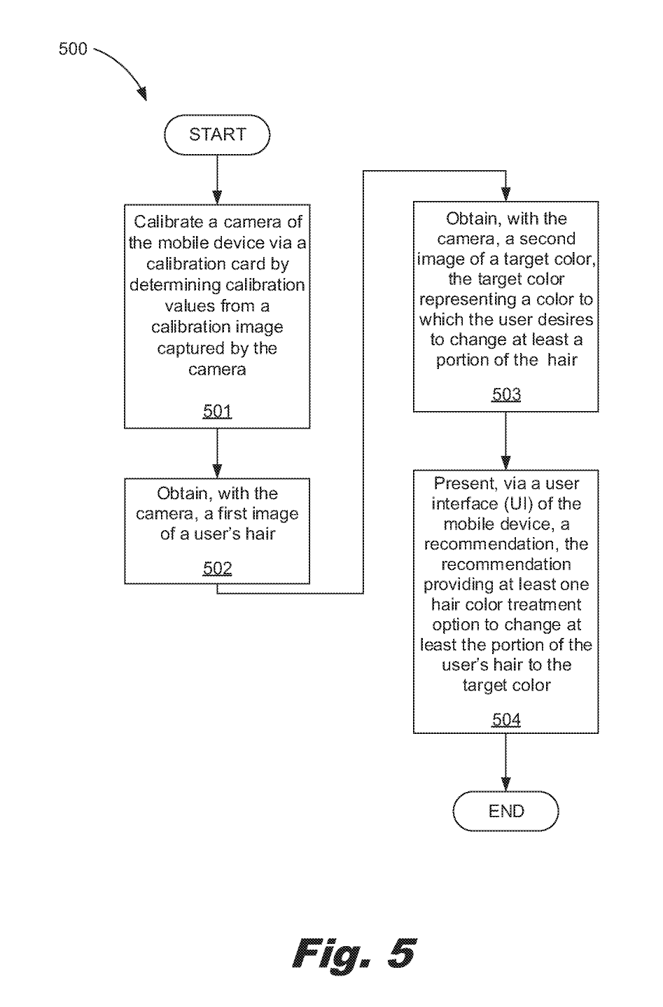

FIG. 5 is a flowchart of a method for determining a hair color treatment option, according to one example of principles described herein. In one example, the method (500) is executed by the system (100) of FIG. 1. In other examples, the method (500) is executed by other systems such as system 200, system 700 or system 800. In this example, the method (500) includes calibrating (501) a camera of the mobile device via a calibration card by determining calibration values from a calibration image captured by the camera, obtaining (502), with the camera, a first image of a user's hair, obtaining (503), with the camera, a second image of a target color, the target color representing a color to which the user desires to change at least a portion of the hair and presenting (504), via a UI of the mobile device, a recommendation, the recommendation providing at least one hair color treatment option to change at least the portion of the user's hair to the target color.

As mentioned above, the method (500) includes calibrating (501) a camera of the mobile device via a calibration card by determining calibration values from a calibration image captured by the camera. The method (500) obtains one calibration image of a calibration card to determine the calibration values. The method (500) obtains several calibration images of the calibration card in several environments with several different types of cameras, settings of the cameras, and mobile devices to determine calibration values for each of the environments. As a result, the calibration images are used to compensate for limiting factors of the mobile devices and environmental factors as described above.

The method (500) includes obtaining (502), with the camera, a first image of a user's hair. The first image captures a single color of the user's hair. The first image captures several colors of the user's hair. In some examples, if the camera of the mobile device has not been calibrated, the first image is invalid if the first image doesn't include a calibration card. As a result, the method (500) prompts the user, via a UI, to capture a calibration image or a first image with the calibration card.

As mentioned above, the method (500) includes obtaining (503), with the camera, a second image of a target color, the target color representing a color to which the user desires to change at least a portion of the hair. The method (500) obtains a second image with one target color. The method (500) obtains a second image with several target colors. In some examples, if the camera of the mobile device has not been calibrated, the second image is invalid if the second image doesn't include a calibration card. As a result, the method (500) prompts the user, via a UI, to capture a calibration image or a second image with the calibration card.

The second image is captured from a number of sources. These sources can include paper sources such as a photograph, a magazine, a printed image, or other paper sources, or combinations thereof. The sources can include digital sources such as a website, a UI, a display or other digital sources, or combinations thereof. The sources can include natural sources such as natural occurring colors found in nature. This can include, for example, vegetation, animals, other organic material, metals, minerals, or other inorganic material, other natural sources, or combinations thereof.

The method (500) includes presenting (504), via a UI of the mobile device, a recommendation, the recommendation providing at least one hair color treatment option to change at least the portion of the user's hair to the target color. In some examples, the recommendation includes one hair coloring product. In other examples, the recommendation includes several hair coloring products.

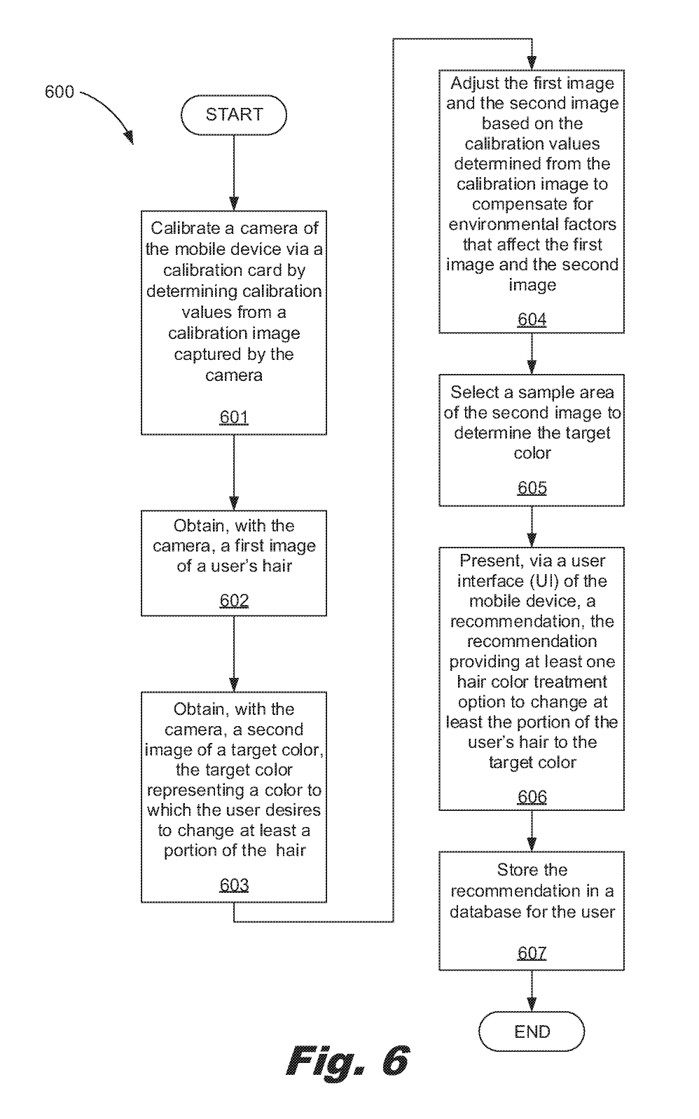

FIG. 6 is a flowchart of a method for determining a hair color treatment option, according to one example of principles described herein. In one example, the method (600) is executed by the system (100) of FIG. 1. In other examples, the method (600) is executed by other systems such as system 200, system 700 or system 800. In this example, the method (600) includes calibrating (601) a camera of the mobile device via a calibration card by determining calibration values from a calibration image captured by the camera, obtaining (602), with the camera, a first image of a user's hair, obtaining (603), with the camera, a second image of a target color, the target color representing a color to which the user desires to change at least a portion of the hair, adjusting (604) the first image and the second image based on the calibration values determined from the calibration image to compensate for environmental factors that affect the first image and the second image, selecting (605) a sample area of the second image to determine the target color, presenting (606), via a UI of the mobile device, a recommendation, the recommendation providing at least one hair color treatment option to change at least the portion of the user's hair to the target color, and storing (607) the recommendation in a database for the user.

As mentioned above, the method (600) includes adjusting (604) the first image and the second image based on the calibration values determined from the calibration image to compensate for environmental factors that affect the first image and the second image. The calibration values are used as an offset as described above for the first image and the second image.

The method (600) includes selecting (605) a sample area of the second image to determine the target color. This includes determining the sample area of the second image related to the target color, analyzing pixels of the sample area, and determining, based on the pixels of the sample area, the target color. In some examples the selected area is a pixel. This allows a very precise representation of the target color. In other examples the sample area is a predefined number of pixels such as 100×100 pixels. If the sample area is a predefined number of pixels, an average RGB value of these pixels is determined. For example, if the sample area is 10,000 pixels, an RGB value is calculated for each of the pixels. The RGB values are then added together to determine a total RGB value. The total RGB value is then divided by 10,000 to determine the average RGB value for the sample area. The average RGB value is then determined to be the target color.

Depending on the resolution of the second image, the predefined number of pixels may be smaller or larger than 100×100.

As mentioned above, the method (600) includes storing (607) the recommendation in a database for the user. This allows the user to lookup a target color they have previously used and how to change their hair color to the target color. This further allows companies to track trends in hair coloring based on geographic locations of users, ages of the users, and develop custom hair coloring products if needed.

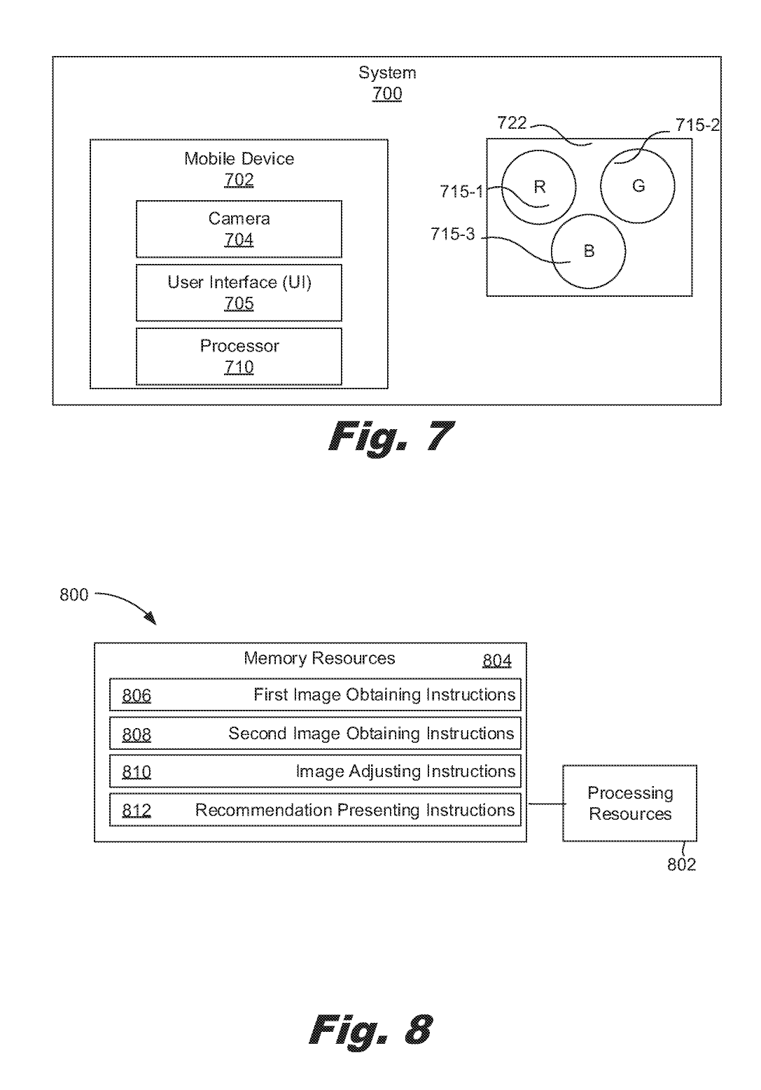

FIG. 7 is a diagram of a system, according to one example of the principles described herein. As will be described below, the system includes a calibration card and a mobile device.

As illustrated, the system (700) includes a calibration card (722). The calibration card is used for calibrating a camera (704) of a mobile device (702). In an example, the calibration card includes a red region (715-1), a green region (715-2) and a blue region (715-3).

The system (700) includes a mobile device (702). The mobile device (702) is programmed to, with the camera (704), obtain a calibration image to calibrate the camera of the mobile device via the calibration card by determining calibration values from the calibration image. In this example, the calibration values are 0. Further, the mobile device (702) is programmed to, with the camera (704), obtain a first image of a user's hair. In this example, the user's hair in the first image is blonde. The mobile device (702) is programmed to, with the camera (704), obtain a second image of a target color. In this example, the target color is pink. As described above, the calibration image, the first image, and the second image are sent to a determining system (110) for subsequent processing to determine the calibration values, the user's hair color and the target color. However, the mobile device (702) might use the processor (710) and memory to execute the subsequent processing. As a result, some or all desired operations are implemented on the mobile device (702).

The mobile device (702) further includes a processor (710). The processor (710) adjusts the first image and the second image based on the calibration values determined from the calibration image to compensate for environmental factors that affect the first image and the second image. In this example, the first image and the second image are adjusted by the calibration values determined above. As a result, some or all desired operations are implemented on the mobile device (702).

The mobile device (702) further includes a UI (705). The UI (705) presents a recommendation. In some example, the UI (705) presents one recommendation. In other examples, the UI (705) presents several recommendations. In this example, the recommendation recommends using hair coloring product X to change the user's blond hair to pink.

FIG. 8 is a diagram of a determining system, according to one example of the principles described herein. In this example, the determining system (800) includes resource(s) (802) that are in communication with a machine-readable storage medium (804). Resource(s) (802) may include one processor. In another example, the resource(s) (802) may further include at least one processor and other resources used to process instructions. The machine-readable storage medium (804) represents generally any memory capable of storing data such as instructions or data structures used by the determining system (800). The instructions shown stored in the machine-readable storage medium (804) include first image obtaining instructions (806), second image obtaining instructions (808), image adjusting instructions (810) and recommendation presenting instructions (812).

The machine-readable storage medium (804) contains computer readable program code to cause tasks to be executed by the resource(s) (802). The machine-readable storage medium (804) may be tangible and/or physical storage medium. The machine-readable storage medium (804) may be any appropriate storage medium that is not a transmission storage medium. A non-exhaustive list of machine-readable storage medium types includes non-volatile memory, volatile memory, random access memory, write only memory, flash memory, electrically erasable program read only memory, or types of memory, or combinations thereof.

The first image presenting instructions (806) represents instructions that, when executed, cause the resource(s) (802) to obtain a first image of a user's hair. The second image presenting instructions (808) represents instructions that, when executed, cause the resource(s) (802) to obtain a second image of a target color, the target color representing a color to which the user desires to change at least a portion of the hair.

The image adjusting instructions (810) represents instructions that, when executed, cause the resource(s) (802) to adjust the first image and the second image based on calibration values determined from a calibration image to compensate for environmental factors that affect the first image and the second image. The recommendation presenting instructions (812) represents instructions that, when executed, cause the resource(s) (802) to present, via a UI, a recommendation, the recommendation providing at least one hair color treatment option to change at least the portion of the hair to the target color.

Further, the machine-readable storage medium (804) may be part of an installation package. In response to installing the installation package, the instructions of the machine-readable storage medium (804) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the resource(s) (802) and the machine-readable storage medium (804) are located within the same physical component, such as a server, or a network component. The machine-readable storage medium (804) may be part of the physical component's main memory, caches, registers, non-volatile memory, or elsewhere in the physical component's memory hierarchy. Alternatively, the machine-readable storage medium (804) may be in communication with the resource(s) (802) over a network. Further, the data structures, such as the libraries, may be accessed from a remote location over a network connection while the programmed instructions are located locally. Thus, the determining system (800) may be implemented on a user device, on a server, on a collection of servers, or combinations thereof.

The determining system (800) of FIG. 8 may be part of a general purpose computer. However, in alternative examples, the determining system (800) is part of an application specific integrated circuit.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for determining a hair color treatment option, the method comprising, with a mobile device programmed to perform the method:
calibrating a camera of the mobile device via a calibration card by determining calibration values from a calibration image captured by the camera;
obtaining, with the camera, a first image of a user's hair;
obtaining, with the camera, a second image of a target color, the target color representing a color to which the user desires to change at least a portion of the hair; and
presenting, via a user interface (UI) of the mobile device, a recommendation, the recommendation providing at least one hair color treatment option to change at least the portion of the user's hair to the target color.

2. The method of claim 1, further comprising adjusting the first image and the second image based on the calibration values determined from the calibration image to compensate for environmental factors that affect the first image and the second image.

3. The method of claim 1, wherein calibrating the camera of the mobile device via the calibration card by determining the calibration values from the calibration image captured by the camera comprises:
obtaining the calibration image of the calibration card from the mobile device;
analyzing pixels of the calibration image associated with a red region, a green region, and a blue region of the calibration card; and
determining, based on the pixels, the calibration values associated with the red region, the green region, and the blue region of the calibration card.

4. The method of claim 1, further comprising selecting a sample area of the second image to determine the target color.

5. The method of claim 4, wherein selecting the sample area of the second image to determine the target color comprises:
determining the sample area of the second image related to the target color;
analyzing pixels of the sample area; and
determining, based on the pixels of the sample area, the target color.

6. The method of claim 5, wherein the sample are is at least a pixel.

7. The method of claim 1, wherein the camera of the mobile device is calibrated before obtaining the first image and the second image from the mobile device.

8. The method of claim 1, wherein the calibration card is included in the first image and the second image to calibrate the camera of the mobile device.

9. The method of claim 1, wherein the second image is captured from a website, a magazine, a UI, or a display.

10. The method of claim 1, further comprising storing the recommendation in a database for the user.

11. A system for determining a hair color treatment option, the system comprising:
a calibration card for calibrating a camera of a mobile device, the calibration card comprising:
a red region;
a green region; and
a blue region;
the mobile device programmed to:
with the camera:
obtain a calibration image to calibrate the camera of the mobile device via the calibration card by determining calibration values from the calibration image;
obtain a first image of a user's hair; and
obtain a second image of a target color, the target color representing a color to which the user desires to change at least a portion of the hair;
with a processor adjust the first image and the second image based on the calibration values determined from the calibration image to compensate for environmental factors that affect the first image and the second image; and
with a user interface (UI) present a recommendation, the recommendation providing at least one hair color treatment option to change at least the portion of the hair to the target color.

12. The system of claim 11, wherein the camera of the mobile device is calibrated via the calibration card by:
obtaining the calibration image of the calibration card from the mobile device;
analyzing pixels of the calibration image associated with the red region, the green region, and the blue region of the calibration card; and
determining, based on the pixels, the calibration values associated with the red region, the green region, and the blue region of the calibration card.

13. The system of claim 11, wherein the UI of the mobile device is used to select a sample area of the second image to determine the target color.

14. The system of claim 13, wherein the sample are is at least a pixel.

15. A machine-readable, non-volatile storage medium encoded with instructions, the instructions executable by a processor of a system to cause the system to:
obtain a first image of a user's hair;
obtain a second image of a target color, the target color representing a color to which the user desires to change at least a portion of the hair;
adjust the first image and the second image based on calibration values determined from a calibration image to compensate for environmental factors that affect the first image and the second image; and
present, via a user interface (UI), a recommendation, the recommendation providing at least one hair color treatment option to change at least the portion of the hair to the target color.

16. The machine-readable, non-volatile storage medium of claim 15, further comprising instructions that, when executed, cause the processor to calibrate a camera of a mobile device via a calibration card by determining the calibration values from the calibration image captured by the camera.

17. The machine-readable, non-volatile storage medium of claim 15, further comprising instructions that, when executed, cause the processor to store the recommendation in a database for the user.

18. The machine-readable, non-volatile storage medium of claim 15, further comprising instructions that, when executed, cause the processor to:
obtain the calibration image of a calibration card from a mobile device;
analyze pixels of the calibration image associated with a red region, a green region, and a blue region of the calibration card; and
determine, based on the pixels, the calibration values associated with the red region, the green region, and the blue region of the calibration card.

19. The machine-readable, non-volatile storage medium of claim 15, further comprising instructions that, when executed, cause the processor to:
determine a sample area of the second image related to the target color;
analyze pixels of the sample area; and
determine, based on the pixels of the sample area, the target color.

20. The machine-readable, non-volatile storage medium of claim 15, wherein a calibration card is included in the first image and the second image to calibrate a camera of a mobile device.
